(19) United States
(12) Patent Application Publication
(10) Pub. No.: US 2006/0021065 A1
(43) Pub. Date: Jan. 26, 2006

(54) Method and device for authorizing content operations

(76) Inventors: Franciscus Lucas Antonius Johannes Kamperman, Eindhoven (NL); Geert Jan Schrijen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,939

(22) PCT Filed: Oct. 15, 2003
(86) PCT No.: PCT/IB03/04538

§ 371 Date: Apr. 19, 2005

(30) Foreign Application Priority Data
Oct. 22, 2002 (EP) 02079390.7

(51) Int. Cl. H04L 9/32; G06F 17/30; G06F 7/04; G06K 9/00; H03M 1/68; H04K 1/00; H04L 9/00; H04N 7/16

(52) U.S. Cl. 726/28

(57) ABSTRACT

Methods of and devices (D1) for authorizing an operation requested by a first user (P2) on a content item (C1) in accordance with a user right (UR1). The user right may identify the first user or a second user (P) and authorizes the user in question to perform the requested operation on the content item. If the user right identifies the second user, the operation is authorized upon receipt of information linking a user right of the first user and the user right of the second user. Preferably the information comprises one or more domain certificates (DC1, DC2) identifying the first and second users as members of the same authorized domain (AD). Preferably a content right (CR1) enabling the operation is used, whereby the user right authorizes the second user to employ the content right.

The invention relates to methods of authorizing an operation requested by a first user on a content item. The invention further relates to devices arranged to perform an operation requested by a first user on a content item.

In recent years, the amount of content protection systems is growing in a rapid pace. Some of these systems only protect the content against illegal copying, while others are also prohibiting the user to get access to the content. The first category is called Copy Protection (CP) systems. CP systems have traditionally been the main focus for consumer electronics (CE) devices, as this type of content protection is thought to be cheaply implemented and does not need bi-directional interaction with the content provider. Some examples are the Content Scrambling System (CSS), the protection system of DVD ROM discs and DTCP, the protection system for IEEE 1394 connections.

The second category is known under several names. In the broadcast world, systems of this category are generally known as conditional access (CA) systems, while in the Internet world they are generally known as Digital Rights Management (DRM) systems.

Recently new content protection systems have been introduced in which a set of devices can authenticate each other through a bi-directional connection. Based on this authentication, the devices will trust each other and this will enable them to exchange protected content. In the licenses accompanying the content, it is described which rights the user has and what operations he/she is allowed to perform on the content. The license is protected by means of some general network secret, which is only exchanged between the devices within a certain household, or, more generally, within a certain domain. This network of devices is thus called an Authorized Domain (AD).

The concept of authorized domains tries to find a solution to both serve the interests of the content owners (that want protection of their copyrights) and the content consumers (that want unrestricted use of the content). The basic principle is to have a controlled network environment in which content can be used relatively freely as long as it does not cross the border of the authorized domain. Typically, authorized domains are centered around the home environment, also referred to as home networks. Of course, other scenarios are also possible. A user could for example take a portable television with him on a trip, and use it in his hotel room to access content stored on his Personal Video Recorder at home. Even though the portable television is outside the home network, it is a part of the user's authorized domain.

The trust necessary for secure intercommunication between devices, is based on some secret, only known to devices that were tested and certified to have secure implementations. Knowledge of the secret is tested using an authentication protocol. The best currently known solutions for these protocols are those which employ ‘public key’ cryptography, which use a pair of two different keys. The secret to be tested is then the secret key of the pair, while the public key can be used to verify the results of the test. To ensure the correctness of the public key and to check whether the key-pair is a legitimate pair of a certified device, the public key is accompanied by a certificate, that is digitally signed by a Certification Authority, the organization which manages the distribution of public/private key-pairs for all devices. In a simple implementation the public key of the Certification Authority is hard-coded into the implementation of the device.

A number of implementations of AD-like DRM systems are known. However, they typically suffer from a number of limitations and problems which make their deployment and acceptance in the market difficult. In particular, an important problem which has not been addressed sufficiently is how to manage and maintain an authorized domain structure which allows a consumer to exercise the rights he has obtained anytime and anywhere he chooses. Current AD solutions typically restrict consumers to a particular and limited set of systems, and do not provide the desired flexibility.

A common approach is to provide the person who buys a content right (a right needed to access a content item, typically containing a necessary decryption key) with a secure personal device like a smart card. During playback, the smart card shares this decryption key with a compliant playback device. The person can now access content as long as he has his smart card with him. This solution suffer from the drawback that a smart card has a limited amount of memory, which means that not all rights can be stored on the card.

An improvement to this system could be to encrypt the content right with the public key of the smart card and to store the rights somewhere, e.g. on multiple locations and e.g. together with the content item. However, it is now not all clear how the content right can be shared with the person's family. At present it is possible for one member of a family to purchase (a right to) a content item, for example a song stored on a compact disc, which he can share with the other members of that family. Consumers are used to such sharing and they expect it from AD-based systems as well. Copyright law typically permits such activities as long as they stay within a particular family. DRM systems try to prevent copying to any third party, and so inadvertently also block this pemmitted type of activity.

The content right could be re-encrypted with the respective public keys of the respective smart cards of the family members. This takes a lot of time and processing power, as all rights have to be processed individually. To check whether it actually is a family member who owns a particular smart card to which the re-encrypted content right is to be supplied a family identifier could be added to the smart card. However, this is not a flexible solution, as it is now very difficult to delete or revoke the content right on one family member's smart card.

It is an object of the present invention to provide authorization methods which allows rights management based on persons instead of devices.

This object is achieved according to the present invention in a method of authorizing an operation requested by a first user on a content item in accordance with a content right containing necessary information for performing the requested operation on the content item and a user right identifying the first user and authorizing the first user to employ the content right. The user right is a single connection between one user and a content right. The content right is required to access a piece of content, for example because it contains a necessary decryption key. Rights management based on persons is achieved by issuing more user rights authorizing persons to employ the content right.

This object is achieved according to the present invention in a method of authorizing an operation requested by a first user on a content item in accordance with a user right identifying a second user and authorizing the second user to perform the requested operation on the content item, in which the operation is authorized upon receipt of information linking a user right of the first user and the user right of the second user. Through user rights, persons can be authorized to perform operations regardless of which devices they wish to use. The linking information allows users to share rights with each other, regardless of devices the content resides on or of any information such as content rights that may be necessary to perform operations on the content. Thus rights management is based on persons instead of devices.

Preferably the linking information comprises one or more domain certificates identifying the first and second users as members of the same authorized domain. It is desirable to be able to share access to the content item with members of a particular family, or more generally a particular domain. To this end, domain certificates (certificates to indicate a group or domain) are issued by a trusted third party to define which persons are member of a particular domain. If the first user now is not authorized to perform the operation, but there is a second user in the same domain who does have such a right, then the first user is still allowed to perform the operation. Preferably user rights can be anywhere in the system.

It is now possible
To personally buy rights to access (certain pieces of) content,
To share such right within the family/household,
To be able to exercise such rights on any device and anywhere (in the world) as a person within the family,
To be able to transfer such rights to others (both inside and outside the family),
To be able to revoke and/or renew rights if necessary,
To cope with changes of the family structure,
To cope with disclosure of rights secrets and illegal acts (e.g. hacking of devices).

In an embodiment the method comprises receiving a content right containing necessary information for performing the requested operation on the content item, the user right of the second user authorizing the second user to employ the content right. Any person can now obtain a user right and thereby exercise the content right, independently of any other user rights that other persons may possess. The content right makes it possible that a device can perform the operation, for example because it contains a necessary decryption key to access the content. A user right authorizes a particular user to employ the content right on the device. This device must check if the right is available and the user is available. A second user is authorized if also a correct domain certificate is available, which connects the two users.

In a further embodiment the operation is not authorized if the content right does not identify the authorized domain. This way content rights can be restricted to the particular authorized domain. Not only does this make rights management more fine-grained, it also limits the damage that can be done by a hacker who manages to obtain decryption keys (provided by content rights) by compromising a device in a particular authorized domain. To further extend this embodiment, optionally the content right could be at least partially encrypted using an encryption key for which the corresponding decryption key is available to devices in the domain. This way the content right is not usable outside the domain.

It is a further object of the present invention to provide devices which allow rights management based on persons.

This object is achieved according to the present invention in a device arranged to perform an operation requested by a first user on a content item in accordance with a content right containing necessary information for performing the requested operation on the content item and a user right identifying the first user and authorizing the first user to employ the content right.

This object is achieved according to the present invention in a device arranged to perform an operation requested by a first user on a content item in accordance with a user right identifying a second user and authorizing the second user to perform the requested operation on the content item, being arranged to authorize the operation upon receipt of of information linking a user right of the first user and the user right of the second user.

Preferably the linking information comprises one or more domain certificates identifying the first and second users as members of the same authorized domain. It is desirable to be able to share access to the content item with members of a particular family, or more generally a particular domain.

In an embodiment the device is arranged to receive a content right containing necessary information for performing the requested operation on the content item, the user right of the second user authorizing the second user to employ the content right. Preferably then at least a portion of the content right is encrypted using an encryption key for which a corresponding decryption key is available to the device. This way, only devices in a particular authorized domain can employ the content right, thereby effectively restricting the content right to the particular domain.

In a further embodiment the content right is provided with a digital signature allowing verification of the authenticity of the content right. Preferably the device then is arranged to perform the operation if the digital signature can be verified successfully using a digital certificate associated with an authorized content provider. This way only the content provider himself can create ‘official’ content rights.

In a further embodiment the device is arranged to perform the operation if the digital signature can be verified successfully using a digital certificate associated with a particular device. This way, personal content (created on that particular device) can also be played back or otherwise used, without the need to involve a third party.

In a refinement of this embodiment the device is arranged to refuse to perform the operation if the digital signature cannot be verified successfully using a digital certificate associated with an authorized content provider and a digital watermark associated with the authorized content provider is present in the content item. This way malicious users cannot create content rights for ‘official’ content, even when they try to pass the ‘official’ content of as personal content, e.g. by creating an analog recording from a television screen.

In a further embodiment the device is arranged to determine a robust fingerprint for the content item and to refuse to perform the operation if the determined robust fingerprint does not match a robust fingerprint comprised in the content right. This way malicious users cannot create content rights for personal content and subsequently try to use those for ‘official’ content.

These and other aspects of the invention will be apparent from and elucidated with reference to the illustrative embodiments shown in the drawings, in which:

FIG. 1 illustrates a model of an authorized domain (AD) based on persons, rights and content;

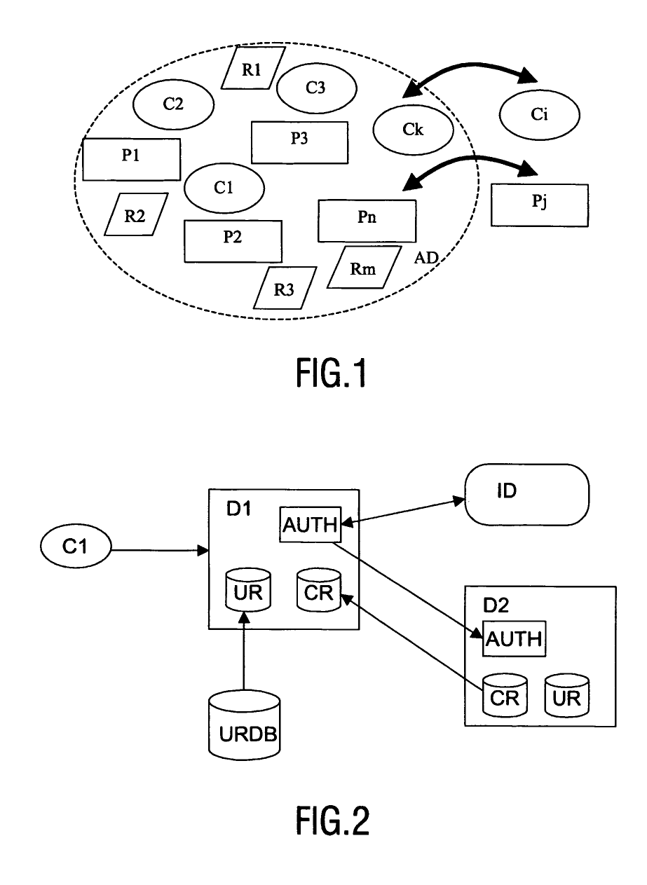

FIG. 2 illustrates an example of a device that is being operated by a user carrying a smartcard who wants to perform an operation on content item; and

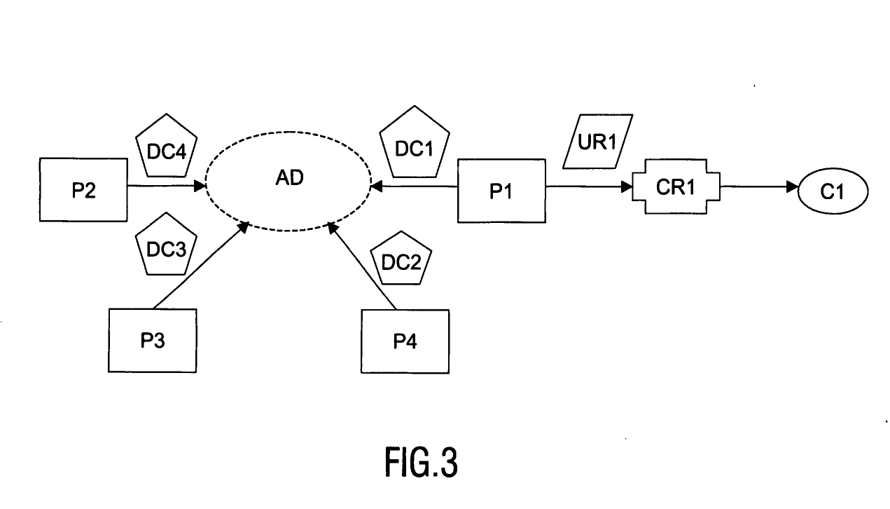

FIG. 3 illustrates how a person can employ another person's user right to exercise a content right if both belongs to the same AD.

Throughout the figures, same reference numerals indicate similar or corresponding features. Some of the features indicated in the drawings are typically implemented in software, and as such represent software entities, such as software modules or objects.

FIG. 1 illustrates a model of an authorized domain (AD) based on persons, rights and content. The authorized domain AD contains content C1, C2, C3, . . . Ck, rights R1, R2, R3, . . . , Rm and persons P1, P2, P3, . . . Pn. The model also shows that content items, e.g. content item Ci, may be imported into the domain or exported from the domain and that persons, e.g. person Pj, may register to the domain or de-register from the domain. For more information on authorized domain architecture and implementation options, the reader is referred to international patent application WO 03/047204 (attorney docket PHNL010880) or international patent application serial number PCT/IB03/01940 (attorney docket PHNL020455).

Some example functions that can be used in the domain given the model of FIG. 1 are:

AD persons membership management:
Person identification (To which AD does a person belong)
Registering of persons to an AD
De-registering persons from an AD
   AD person-rights link management:
Persons-rights link identification (Which person may use a right)
Linking a right to a person
Disconnect a person-right link

We have to note that in practice content can only be accessed/used by means of a user operating a device. In the following text we assume that devices used in the system are compliant and “public” devices. This means that a device will adhere to certain operation rules (e.g. will not illegally output content on a digital interface) and that ownership of a device is not important (public). Device compliancy management, i.e. compliant device identification, renewability of devices, and revocation of devices, will be assumed to be in place (using known techniques), and will not be considered further here. The content right can be used to do device compliancy management.

The user right is a single connection between one user and a content right (which is required to decrypt a piece of content). By introducing this user right we now have five main entities in our system that could work as follows:
content: content items are encrypted (there are many options, for example with a unique key per content title) and can be anywhere in the system.
content right: contains rules (e.g. restricted to viewers 18 years or older, or European market only) and key(s) to access a certain content item. The system is flexible in the sense that content rights can be made unique per content title or even unique per specimen (copy) of content. Content rights should be only transferred to compliant devices. A more secure rule is to enforce that content rights may be only transferred to compliant devices that are operated by authorized users (i.e. users that are authorized to have access to the specific content right by means of their user rights). Content rights might also be stored together with the content on for example an optical disk.
user right: a certificate issued by the content provider that authorizes a person to use a certain content right (belonging to a certain piece of content). User rights can be in principle anywhere in the system. The SPKI authorization certificate (implemented compliant to e.g. X.509) could be used to implement such a user right.
device: A (compliant) device can identify a user by means of a personalized identification device (such as a smart-card) or e.g. a biometric (or both) and collect certificates (e.g. from the smartcard, or from other devices) that prove that the user is allowed to use a certain content right. This content right could be obtained from the smart-card where it was stored (if it was stored there), or be obtained (securely transferred) from another device on the network (after showing the appropriate certificate chain).
user: A user is identified by some biometric or preferably by a personalized identification device (e.g. a smartcard) that he/she is carrying. The latter is preferred since it allows users to carry rights with them (for accessing content on off-line devices) and generate signatures to issue their own certificates (user rights). The identification device may itself be protected by a biometric authentication mechanism, so that anyone other than the legitimate owner cannot use the identification device.

FIG. 2 illustrates an example of a device D1 that is being operated by a user carrying a smartcard ID who wants to perform an operation on content item C1, for example a rendering of the content item, a recording of the content item, a transfer of the content item or a creation of a copy of the content item. The device D1 obtains a user right, preferably embodied as a digital certificate, from a remote database URDB on the Internet and stores it in local storage medium UR.

The content rights, also preferably embodied as digital certificates, that are required to perform the operation on the content item C1 are obtained from a second device D2 and stored in local storage medium CR. Before starting the transfer of content rights, device D2 checks the user rights of the user (this depends on the rules for transferring content rights as is said before) and whether the device D1 is compliant. To this end devices D1 and D2 are provided with respective authentication modules AUTH. These modules could for example comprise respective private keys from a public/private key pair and certificates for the associated public keys, allowing public-key based authentication.

The operation on the content item C1 is authorized if there is a content right containing necessary information for performing the requested operation on the content item C1 and a user right identifying the first user and authorizing the first user to employ the content right. In other systems, the use of a separate content right may not be necessary, for example if all operations on content in the system are always authorized.

If there is no user right authorizing the user to perform the operation, or there is no user right authorizing the first user to employ the content right, then normally the operation is not performed. However, the operation may still be authorized if information linking a user right of the first user and the user right of the second user is received. Such information can be of any type, for example a certificate identifying both users or a listing on a Web server indicating the user rights are linked. The information could also be contained in one (or both) of the user rights themselves. Preferably it is provided in the form of one or more domain certificates, as discussed below.

The presented solution assumes the availability of a public key infrastructure in which users, content owners and other trusted third parties maintain their own unique private/public key pair and can issue certificates by signing with their private key. One of the possibilities is to use certificates as defined in the SPKI/SDSI framework.

In order to introduce the notion of Authorized Domain, we propose to introduce another type of certificate into the system. A certificate, which we call a domain certificate, is issued by a (trusted) third party that defines what persons/entities belong to a certain domain. Such a certificate contains the identifier (e.g. biometric, public key) of the subject (a person) and the identifier (e.g. name, public key) of the authorized domain the subject is declared to be part of. The certificate is signed with the private key of the issuing trusted party. Furthermore the certificate must contain the usual fields like ‘date of issue’ and ‘validation date’ in correspondence with an appropriate revocation system. The SPKI ‘name certificate’ could be used to implement this domain certificate.

For example, one can now define one household-domain to every user, which defines the household a person is living in. This could be done by letting the municipality (or a representative thereof) issue a certificate declaring the registered street and address of a user. Such a certificate creates a single connection between a person (user) and his family.

The domain certificates can be implemented in a variety of ways. In one embodiment, every user is issued a separate domain certificate identifying him as a member of a particular authorized domain. A comparison of the respective AD identifiers in two respective domain certificates establishes whether two users are members of the same domain. This way every domain certificate can be managed separately and a person's domain certificate is not affected when another person joins or leaves the authorized domain.

In another embodiment, identifiers for members of a single authorized domain are enumerated in a single domain certificate. This way it is much easier to check whether two persons belong to a single authorized domain. Furthermore, every person now automatically has the AD membership information of all other members of his domain available, without requiring a separate certificate to be retrieved. However, when a new person joins the AD, all persons must be issued new domain certificates.

Granting access to content to people living in the same authorized domain can now be done as follows. If a person P1 living in authorized domain (household) AD has the user right to exercise the content right CR1 to e.g. play back content item C1, a second person P2 could also exercise the right CR1 if he belongs to the same household AD by presenting the following certificates to a compliant device D1:
user right UR1 signed by content provider showing P1 has the right to exercise CR1
domain certificate DC1 signed by municipality showing P1 is a member of AD
domain certificate DC2 signed by municipality showing P2 is a member of AD

This situation is depicted in FIG. 3. Note that it is assumed that the device D1 knows a certain root public key in order to check that a certificate was signed by the true authorized issuer.

Optionally the content provider may only allow other persons within the domain to play the content under certain circumstances. In this case this should be stated in the user right by means of some extra bits. Besides stating the permissions concerning usage within the domain, other flags or bits could be added to user right certificates. For example bits dealing with permission for a first generation copy or for one-time playback could be added in the certificates. Such bits could also be added to the content right CR1, and then they would apply regardless of which user right was used to exercise the content right.

The system also allows for so-called cross authorized-domain rights. These are rights that allow content to cross the borders of the authorized domain. This can be achieved by adding extra fields in the user right that indicate the allowed cross-domain behavior that compliant devices have to obey. A field in the user right could for example contain a statement like ‘XAD=no’ meaning that no user rights certificates should be issued to users outside the household authorized domain. The delegation tag in SPKI authorization certificates could be used for this purpose. This way, serial copy management can be implemented that can limit copies up to one generation. It may also be desirable to implement ‘copy-once’ restrictions.

To make the system well manageable and consistent, several root public keys need to be known by the device. This is necessary in order to check certificates (and certificate chains) that exist in the system. Some of the root/master keys of trusted third parties within the system that the device must know are listed below:
root key of content owner or representative: for checking user rights (User rights management).
root key of device compliancy manager: for checking whether other devices in the system are (still) compliant (Device compliance management).
root key of naming authority (e.g. government that issues household-domain certificates): for checking the relations within an authorized household domain (Domain management).
root key of user management: for checking whether key pairs of individual users (Smartcards) are authentic and have not been compromised (User management).

Ownership of rights and the composition of a family (or other domain) may vary over time. Besides, devices may be hacked or secret keys might become known. We therefore have to consider dynamic behavior for the following cases:
Domain (Family membership) management: The composition of a family may change.
User rights management: User rights may change; A user may give away the right to someone else.
User management: An ID device may be hacked, or a person may e.g. pass away.
Device compliance management: Devices may be hacked and then must be revoked/renewed.

The composition of a family is represented in a certificate, i.e. the certificate lists the members of the family. The system deals with changes in the family composition by using domain certificates, listing the family members, with limited validity date. After the validation date has expired the family must apply for a new certificate at some trusted third party. The community administration could for example act as such a trusted third party and take into account changes in the family composition.

Note that dates/time can be easily, reliably, and securely transferred to devices by including this date/time in content or user rights. This enables the mechanism that a device may only accept a domain certificate if its date is later than the date in the user rights or content right. The device may also store the date/time for future use as a lower boundary to the “current” time. Also some kind of sequence numbering mechanism could be used in usage and content rights to achieve similar effect for accepting the domain certificate.

A user right may also be used to distribute new domain certificates to a family. This even seems preferable. If a family member wants to use and retrieve the user right he then automatically receives the new domain certificate. This method implies that the usage certificate distributor also distributes the domain certificates (, which might be made by another party of course).

A revocation mechanism for household certificates seems not very useful as such revocation certificates could be blocked and their distribution cannot be guaranteed. Revocation messages could be distributed with user rights (or with local content rights).

User rights will also be dealt with using validity dates. Such a validity date may also be set to infinite. We now, however, still need to deal with transfer of user rights (i.e. a move operation). The most difficult case is for a user right with an infinite validity date. Some possible solutions are:
Do not provide this option.
Do transfer with use of the service provider, give new user right, revoke old right:
Send a revocation message to the user ID device (if available) and store it. When a user wants to access content the device, which is used to access the content, will consult the revocation list in the user ID device, and
Put a revocation message in the domain certificate (Certificate might become very large, not very scalable solution) and require that besides presenting the usage certificate also the domain certificate must be presented when accessing content.
Transfer the user right with help of the user ID device (new signature with own private key), add revocation data in ID device, and transmit revocation data to other family members. Issue user certificates with validity dates, which at some moment in time need to be renewed. Require that an external revocation database is consulted before using a user right.

As stated before a person may be identified on the basis of his biometric data or on the basis of an ID device (e.g. a wireless smart card, the mobile telephone, etc.) belonging to that person. Biometric data will go along with the person and managing these data is “automatic”. An ID device, however, could be hacked and duplicated, lost, etc. To handle such “events” requires care management of ID devices.

Suppose an ID device operates with some public key algorithm using a public/private key pair. The best seems here to also have validity dates for ID devices (or that at a certain moment in time, for new content a new ID device is required). In case a private key becomes known, first of all the device ID should be revoked. Such a revocation message might be included in new content rights or in new user rights. Furthermore the person should be removed from the family certificate. This gives an extra hurdle to hackers being now unable to access content owned by family members.

Note that updating of the ID device could be done automatically when a person buys content, i.e. obtains a usage certificate.

Device compliancy management can be done on the basis of distribution of content rights. Only compliant devices are allowed to obtain content rights. Different technologies might be used to perform device management and secure content right distribution, e.g. using Secure Authenticated Channels (SACs) and certificates and e.g. using MKB structures as used in CPPM and CPRM (see http://www.4centity.com/).

One particular solution uses two types of content rights: global rights (can be used all over the world) and personal/family rights (should remain locally at the user who bought it and may not be distributed). The reason is that this enables the use of counting mechanisms in rights, which is not possible with user rights, which have been signed by a service provider.

In the case of specific/counting rights the content right should be made a personal/family right. The user right should indicate if a global or the personal/family content right must be used. To make it more generic: Different content rights for a specific piece of content are allowed. The user right indicates what specific content right should be used.

Content rights could contain revocation data for user rights and person ID devices or an instruction to contact to a certain revocation database before content is played back. Time based rights could be implemented by requiring a hart beat mechanism to get time (see for example international patent application WO 03/058948, attorney docket PHNLO20010).

A critical assumption is that content rights are only transferred to devices that are compliant and are operated by users that have the appropriate user rights. This assumption may not always be true, since in the real world it can not be held impossible for a secret key (required to decrypt some piece of content) to leak. If this happens, a hacker could create a new content right for the same piece of content but with fewer limitations than the original content right. In general, the content provider might not like the idea that anyone can create content rights, which makes it possible for any content to enter the system.

The best way to solve the problem sketched above, is for the content provider to digitally sign content rights. Furthermore it must be enforced that (compliant) devices check the signatures on content rights and only accept content rights that are properly signed by the content provider. Therefore devices must know the (root) public key of the content provider. Of course it is not mandatory for content rights to be signed.

An additional advantage of this method is the fact that less (root) public keys have to be known to the compliant device. A compliant device has to know (roots of) public keys of amongst others the issuer of user rights, device compliancy manager and naming authority. These values would have to be stored in the device in some way. However if content rights are signed by the content provider, these public keys can be simply added to the content right. Only the (root) public key of the content provider has to be known by the device. This way the content provider can determine who is authorized to issue user rights, compliancy certificates and naming certificates.

Furthermore, information concerning where to check certificate revocation information can be added to content rights. A hacker can not change all this additional information in the content right since a valid content right must be digitally signed by the content provider.

Only allowing content rights that are signed with the private key of the official content provider, denoted as CP works fine for securely introducing content into the system that is coming from CP. However, if users want to introduce personal content (like personal photos or home video recordings of their last holiday) into the system, they should first involve CP in order to create the required content rights. This is an undesired situation since CP should not have the power to control personal content. So a first step in order to allow personal content in the system is to allow content rights to be signed by someone else than the CP.

The first rule we introduce is that content rights that are not issued by CP must be signed by a compliant device. If this is not the case, the content rights should be rejected by any (compliant) device that wants to use these rights. This means that personal content can only enter the system via a compliant device. Such a compliant device should furthermore check that there is no watermark present in the content. Watermarked content is originally coming from CP and therefore users are not allowed to create their own content rights for such content.

The solution presented so far is not completely safe yet, since it allows for a typical attack. Assume that a user has created a content right for a certain piece of self-made content. Now a malicious user could substitute the content by another piece of content after the content right was made (and thus after the compliant device signed it)! Therefore he has to (re)encrypt the (illegal) content with the content key that is in the approved content right and give this content the same identifier as the self-made content for which the content right was made. So lots of illegal content can enter the system if it is encrypted with the same (leaked) content key.

In order to solve this issue, there must be a secure link between a content right and the actual piece of content. The usage of fingerprints of content can provide this link. A fingerprint of a content item is a representation of the information signal in question which does not change when the content item is modified slightly. Such fingerprints are sometimes also known as “(robust) hashes”. The term robust hashes refers to a hash function which, to a certain extent, is robust with respect to data processing and signal degradation, e.g. due to compression/decompression, coding, AD/DA conversion, etc. Robust hashes are sometimes also referred to as robust summaries, robust signatures, or perceptual hashes. An example of a method of generating a fingerprint is disclosed in international patent application WO 02/065782 (attorney docket PHNL010110).

A content right now should contain some extra information stating what fingerprint can be found in exactly what part of the content. So instead of adding fingerprint information of the total piece of content (which would be a large amount of data) the fingerprint information at certain specific points in time (together with these time values) can be added. The compliant device adds this fingerprint information to the content right before signing it. When a content right is used (e.g. to play content) the compliant device must check whether the fingerprint data that is included in the content right can also be found in the actual content (at the indicated points in time). If this is not the case, the content right must be rejected.

Summarizing, this embodiment comprises the following:
Content from the ‘official’ content provider CP must be watermarked and content rights must contain fingerprint information about the content they are linked to.
When content rights for personal content are created, compliant devices (or content/service provider) must check that there is no watermark present.
Compliant devices must add fingerprint information to a new content right (for personal content) before signing it.
Compliant devices that want to use content rights must check if the fingerprint information in the content right matches with the actual content.

Like in the original system, the creator of a content right determines what (root) public keys of user right issuer, naming authority and device compliancy manager must be checked in order to access the content. So a user can authorize any party (including himself or his own device) to issue the accompanying user rights for his personal content.

The idea of having input devices sign fingerprint information of content closely matches the ideas in international patent application serial number PCT/IB03/00803 (attorney docket PHNL020246). However, our solution is more specific and makes a clear distinction between official content from the content provider (waternarked) and personal content.

In the case that content is watermarked, a compliant device will only play the content if it has the appropriate content rights signed by the official content provider (of which the public key is known). If no watermark is detected, the content is classified as ‘personal content’ and the accompanying content rights may be signed by any compliant device.

As a further optional extension, it is possible to “personalize or domainize” content rights on the domain level. This can be done generally by having compliant devices arranged to refuse to perform the operation if the authorized domain is not identified in the content right. This way, if the content right identifies the “wrong” domain (or no domain at all) the person from the authorized domain cannot exercise it. This approach, however, has some risks, given the possibly enormous amount (tens of millions is possible) of future compliant devices: As one device gets hacked (and is not sufficiently fast revoked) this may be a leak to all content rights in the complete system.

Preferably this personalization/domainization is done by encrypting the content right using an encryption key for which a corresponding decryption key is available to the devices in the authorized domain. The decryption key typically would be available in the identification device. The content provider encrypts a content right with an extra key CREK (Content Right Encryption Key) as follows:
E{CREK}[Content right].

Subsequently this key is encrypted with the public domain key (PDK) available to all domain members in their ID card (the content provider has obtained this key during a buy transaction from the ID-card and therefore can use it). The encrypted CREK will be concatenated with the content right:
E{PDK}[CREK]∥E{CREK}[Content right]
   and then sent to the user together with the content (if required).

If we assume that all identification devices (e.g. smartcards) have the SDK (Private (secret) Domain Key) on board, then after user identification, the protocol for playback may operate as follows:

Playback device sends to user id-device:
E{PDK}[CREK]∥PK_Playback_device

The user id-device retrieves CREK by decryption with the SDK and then encrypts CREK with the public key of playback device PK_Playback_device.

Then the user_id device sends to the playback device:
E{PK_Playback_device}[CREK]

The playback device can now retrieve the CREK and subsequently decrypt the content rights and decrypt the content.

To summarize, in the following two tables the different data elements and their functions are listed. These tables are meant for illustrative purposes only and are not exhaustive. Table 1 lists system functions and corresponding data elements.

| Data elements | Management function | Mechanism |
|---|---|---|
| Content right | Device compliancy | Only distribute |
| | enforcement | content right |
| | | to compliant devices |
| User right | Rights management | Only distribute |
| | | “user rights” |
| | | to paying users |
| Domain | (Authorized) Domain | Determine who |
| certificate | management | belongs to a |
| | | domain |
| User ID | User identification | Secure way to |
| | | identify users |

Table 2 lists data elements, their function and contents. Many of these functions are of course optional.

| | Location | Function | Management | Management |
|---|---|---|---|---|
| Content | Global for | Indicates | Contains | May contain |
| right | global access | the rules | signed date | revocation |
| | Personal in | to access | field. Used | messages for |
| | case of | the content | to distrib- | user IDs |
| | updatable | and contains | ute “latest” | |
| | content | content key | date to | |
| | rights | to access | devices and | |
| | Domainize for | content | ID card | |
| | extra | | May contain | |
| | security | | white list | |
| | | | for user | |
| | | | rights | |
| Usage | Global | Identifies | May contain | May contain |
| certif- | | the user | signed new | revocation for |
| icate | | which may | date | user certificate |
| | | “use” a/ | May contain | May contain |
| | | which con- | updated | revocation for |
| | | tent right | domain | domain |
| | | (Global or | certificates | certificate |
| | | personal), > | (will auto- | |
| | | which date | matically | |
| | | in content | distribute) | |
| | | right etc. | | |
| Domain | Global | Identifies | Has validity | May contain |
| certif- | | the members | date: After | revocation for |
| icate | | of the | expiration | user certif- |
| | | family | date must be | icates |
| | | | updated | |
| User cer- | In ID | Identifies | Has validity | May contain |
| tificate | card user | a user; | date: After | revocation for |
| (Bio- | | May addi- | expiration | usage |
| metric | | tionally | ID card | certificate |
| data) | | store other | must be | |
| | | data | updated. | |

An example of the best way to implement the invention, as presently contemplated by the inventors, will now be discussed. This implementation of the system uses the SPKI/SDSI framework. See SPKI Certificate Theory (Internet RFC 2693) and Carl Ellison, Improvements on Conventional PKI wisdom, 1st annual PKI Research Workshop, April 2002. Inplementation within the X.509 framework is also considered possible. It is assumed that every entity maintains its own public/private key pair. Public and private keys will be indicated with the symbols PK and SK respectively.

An SPKI name certificate is represented as a 4-tuple (K, A, S, V):
K=issuer's public key
A=local name being defined
S=certificate's subject
V=validity specification

An SPKI authorization certificate is represented as a 5-tuple (K, S, D, T, V):
K=issuer's public key
S=certificate's subject
D=delegation bit
T=tag that specifies the permission being granted
V=validity specification

If the delegation bit is set to true, the subject may further delegate the permission (which is specified in the tag) to other keys and names.

An authorized domain can be formed by letting some central authority issue SPKI name-certificates that bind a person's public key to an official unique identifier (for example, name and address information). An example of such a certificate (in SPKI form) in which ‘address authority’ AA is providing access to person ‘P1’: Cert1=SK_AA{(K, A, S, V)} meaning a 4-tuple signed by SK_AA (i.e. the private key of the address authority), where:
K=PK_AA
A=street address and number
S=PK_P1

Note that for simplicity validation specifications are left out here. They should be chosen in conformance with the revocation and renewability system.

An alternative solution is to just group the PKs of all persons in the authorized domain in a single domain certificate. This has the additional advantage that only one domain certificate is needed. An example of how such a certificate might look like is Cert1b=SK_AA{(K, A, S, V)} meaning a 4-tuple signed by SK_AA (i.e. the private key of the domain authority), where:
K=PK_AA
A=household certificate
S=PK_P1, PK_P2, PK_P3, . . .

Now assume there is a Content Right CR1 that holds the rules and keys that are required to play a certain piece of content. A content owner C01 can authorize person P1 by issuing the following certificate: Cert2=SK_CO1 {(K, S, D, T, V)} with:
K=PK_CO1
S=PK_P1
D=false
T=CR1

In certificate Cert2 the delegation bit D is set to false, which indicates that the user is not allowed to delegate the user right (of content right CR1) to another user. If the delegation bit is set to ‘true’, then person P1 is allowed to delegate the permission. The total system can be designed so that compliant devices still allow other users within the same (authorized) to use CR1 and play the content item. The delegation bit in this case prevents spreading of rights outside of the authorized domain.

A user obtains access to content via a device. A compliant device will only provide access (decrypt content with the key that is in the Content Right) if the user owns the proper set of certificates. Note that probably the device won't even get a content right if there is no authorized user!

The certificates belonging to a user can be retrieved from any location on the network or stored on the user's smartcard. Content rights may also be stored on the smartcard. This is required for playing content on offline devices. It might be useful to allow content rights to be stored on some trusted proxy of the user that is accessible through the network. This way the user can still retrieve content rights that are not stored on his smart card and are not available elsewhere on the network.

The following list presents some fields in a certificate that might be required (or useful) when implementing the solution. The list only shows fields, other than the standard SPKI certificate fields that were mentioned before:
signing date
device identifier on which certificate was signed (facilitates collection of reputation-info of devices which can lead to revocation in the device compliancy subsystem)
copy once/copy never/copy no-more and similar flags
locations/servers of revocation system

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

In summary, the invention provides for methods of and devices (D 1) for authorizing an operation requested by a first user (P2) on a content item (C1) in accordance with a user right (UR1). The user right may identify the first user or a second user (P1) and authorizes the user in question to perform the requested operation on the content item. If the user right identifies the second user, the operation is authorized upon receipt of information linking a user right of the first user and the user right of the second user. Preferably the information comprises one or more domain certificates (DC1, DC2) identifying the first and second users as members of the same authorized domain (AD). Preferably a content right (CR1) enabling the operation is used, whereby the user right authorizes the second user to employ the content right.

1. A method of authorizing an operation requested by a first user on a content item in accordance with a user right identifying a second user and authorizing the second user to perform the requested operation on the content item, in which the operation is authorized upon receipt of information linking a user right of the first user and the user right of the second user.

2. The method of claim 1, in which the information comprises one or more domain certificates identifying the first and second users as members of the same authorized domain.

3. The method of claim 2, in which the one or more domain certificates comprise a first domain certificate identifying the first user as a member of an authorized domain, and a second domain certificate identifying the second user as a member of the authorized domain.

4. The method of claim 2, in which the one or more domain certificates comprise a single certificate identifying the first and second users as members of the authorized domain.

5. The method of claim 1, in which the operation comprises at least one of: a rendering of the content item, a recording of the content item, a transfer of the content item and a creation of a copy of the content item.

6. The method of claim 1 or 2, comprising receiving a content right containing necessary information for performing the requested operation on the content item, the user right of the second user authorizing the second user to employ the content right.

7. The method of claim 6 as dependent from claim 2, in which the operation is not authorized if the content right does not identify the authorized domain.

8. A device arranged to perform an operation requested by a first user on a content item in accordance with a user right identifying a second user and authorizing the second user to perform the requested operation on the content item, being arranged to authorize the operation upon receipt of of information linking a user right of the first user and the user right of the second user.

9. The device of claim 8, in which the information comprises one or more domain certificates identifying the first and second users as members of the same authorized domain.

10. The device of claim 9, in which the one or more domain certificates comprise a first domain certificate identifying the first user as a member of an authorized domain, and a second domain certificate identifying the second user as a member of the authorized domain.

11. The device of claim 9, in which the one or more domain certificates comprise a single certificate identifying the first and second users as members of the authorized domain.

12. The device of claim 8, being arranged to receive an identifier for the first user from an identification device and to perform the operation if the received identifier matches the identification of the first user in the user right of the first user.

13. The device of claim 8 or 9, being arranged to receive a content right containing necessary information for performing the requested operation on the content item, the user right of the second user authorizing the second user to employ the content right.

14. The device of claim 11, in which at least a portion of the content right is encrypted using an encryption key for which a corresponding decryption key is available to the device.

15. The device of claim 13, in which the content right is provided with a digital signature allowing verification of the authenticity of the content right.

16. The device of claim 15, being arranged to perform the operation if the digital signature can be verified successfully using a digital certificate associated with an authorized content provider.

17. The device of claim 15, being arranged to perform the operation if the digital signature can be verified successfully using a digital certificate associated with a particular device.

18. The device of claim 15, being arranged to refuse to perform the operation if the digital signature cannot be verified successfully using a digital certificate associated with an authorized content provider and a digital watermark associated with the authorized content provider is present in the content item.

19. The device of claim 13 or 15, being arranged to extract a public key from the content right and to use the extracted public key in determining whether the operation is authorized.

20. The device of claim 13, being arranged to determine a robust fingerprint for the content item and to refuse to perform the operation if the determined robust fingerprint does not match a robust fingerprint comprised in the content right.

21. The device of claim 13 as dependent from claim 9, being arranged to refuse to perform the operation if the authorized domain is not identified by the content right.

22. A method of authorizing an operation requested by a first user on a content item in accordance with a content right containing necessary information for performing the requested operation on the content item and a user right identifying the first user and authorizing the first user to employ the content right.

23. A device arranged to perform an operation requested by a first user on a content item in accordance with a content right containing necessary information for performing the requested operation on the content item and a user right identifying the first user and authorizing the first user to employ the content right.

24. The device of claim 23, in which at least a portion of the content right is encrypted using an encryption key for which a corresponding decryption key is available to the device.

25. The device of claim 23, in which the content right is provided with a digital signature allowing verification of the authenticity of the content right.

26. The device of claim 25, being arranged to perform the operation if the digital signature can be verified successfully using a digital certificate associated with an authorized content provider.

27. The device of claim 25, being arranged to perform the operation if the digital signature can be verified successfully using a digital certificate associated with a particular device.

28. The device of claim 25, being arranged to refuse to perform the operation if the digital signature cannot be verified successfiilly using a digital certificate associated with an authorized content provider and a digital watermark associated with the authorized content provider is present in the content item.

29. The device of claim 23, being arranged to determine a robust fingerprint for the content item and to refuse to perform the operation if the determined robust fingerprint does not match a robust fingerprint comprised in the content right.

30. The device of claim 23, being arranged to receive an identifier for the first user from an identification device and to perform the operation if the received identifier matches the identification of the first user in the user right.
